(19) United States
(12) Patent Application Publication
(10) Pub. No.: US 2025/0307865 A1
(43) Pub. Date: Oct. 2, 2025

(54) IDENTIFYING HIGH-ENGAGEMENT CONTENT ITEMS ON DIGITAL CONTENT PLATFORMS

(71) Applicant: Roku, Inc., San Jose, CA (US)

(72) Inventors: Abhishek Majumdar, Santa Clara, CA (US); Takanori Maehara, London (GB); Ye Wu, Cupertino, CA (US); Nitish Aggarwal, Sunnyvale, CA (US)

(73) Assignee: Roku, Inc., San Jose, CA (US)

(21) Appl. No.: 18/621,957

(22) Filed: Mar. 29, 2024

(51) Int. Cl. G06Q 30/0207; G06Q 30/0204

(52) U.S. Cl. CPC G06Q 30/0224; G06Q 30/0204

(57) ABSTRACT

Determining content items promote long-term user engagement with a digital content platform is not trivial. Online learning systems or simulations that aim to learn and predict such content items are expensive to implement and may not always converge. One approach can involve modeling long-term engagement by examining user trajectories extracted from offline user session data. User trajectories may include user interactions with the platform over a long period of time. Rewards for a particular content item can be calculated using the user trajectories, where a reward is based on a window of user interactions that follows a user interaction with the particular content item. An estimate for the engagement score for the particular content item can be determined from the rewards. The engagement scores of various content items can be used as training data to train a model that can make inferences on long-term engagement potential of a content item.

### TECHNICAL FIELD

This disclosure relates generally to content recommendation systems, and more specifically, using offline data to identify high-engagement content items on digital platforms.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a content item retrieval system that uses engagement scores, according to some embodiments of the disclosure.

FIG. 2 illustrates a content item recommendation system that uses engagement scores, according to some embodiments of the disclosure.

FIG. 3 illustrates engagement scoring based on user session data, according to some embodiments of the disclosure.

FIG. 4 illustrates exemplary user session data, according to some embodiments of the disclosure.

FIG. 5 illustrates an exemplary user trajectory and rewards calculated based on the user trajectory, according to some embodiments of the disclosure.

FIG. 6 illustrates another exemplary user trajectory and rewards calculated based on the user trajectory, according to some embodiments of the disclosure.

FIG. 7 illustrates a box plot of a probability distribution formed from the rewards, according to some embodiments of the disclosure.

FIG. 8 illustrates training a model using content items and their corresponding engagement scores, according to some embodiments of the disclosure.

FIG. 9 is a flow chart illustrating a method for determining engagement scores, according to some embodiments of the disclosure.

FIG. 10 is a flow chart illustrating a method for outputting one or more content items based on the engagement scores, according to some embodiments of the disclosure.

FIG. 11 is a flow chart illustrating a method for training a model, according to some embodiments of the disclosure.

FIG. 12 is a block diagram of an exemplary computing device, according to some embodiments of the disclosure.

### DETAILED DESCRIPTION

### Overview

Digital content platforms offer users access to large libraries of content items. One technical task for such platforms is to develop methods and systems that help build strong user trust and habits over time. Rather than serving trendy or popular items that only grab a user's attention momentarily only, the methods and systems can identify and serve content items that encourage users to return and stay engaged with the platform. The methods and systems can identify a set of items that can potentially result in high engagement of users in a given window/period of time in the future. By serving (e.g., outputting, presenting, showing, and/or displaying, etc.) content items that are likely to encourage long-term engagement, platforms can retain and keep users on the platform over a long period of time. Having more engaged users on the platform can boost overall loyalty, increase usage of the platform (e.g., number of active users, number of hours users spend on the platform, etc.), and potentially increase revenue.

Identifying and determining content items promote long-term user engagement with a digital content platform is not trivial. Besides identifying the content items, it may be useful to identify features or characteristics of content items which promote long-term user engagement with the platform. Moreover, given a particular content item (and its features/characteristics), it may be useful to be able to predict how well the content item would promote long-term user engagement with the platform. Additionally, it may be useful to be able to make predictions or inferences conditioned on the demographics or contextual factors.

Online learning systems or simulations that aim to learn and predict such content items are expensive to implement and may not always converge. Online systems may run real-time experiments on live users and observe the users' engagement on the platform over time. Such online systems can be expensive due to large amounts of data collection being collected over long A/B testing durations. Such online systems may cause users to lose interest or cause user engagement to decrease due to random exploration (e.g., the online system serving random content items to test users). Online systems that run the experiments on simulated users or online systems that simulate random exploration can be expensive to implement.

One practical and effective approach can involve modeling long-term engagement by examining user trajectories extracted from offline user session data. User session data can include historical logs of user interactions on the platform over many sessions with the platform. User trajectories may include user interactions with the platform over a long period of time (e.g., 30 days or more). User trajectories can be extracted from user session data for many users of the platform, e.g., a population of users of the platform. User trajectories may be extracted based on a model that measures long-term engagement. Different models may use different indicators to measure long-term engagement. Preferably, one or more types of user interactions of a particular user can be extracted from user session data to form a user trajectory. The type(s) of user interactions may depend on the model, e.g., the indicators or metrics used by the model to measure long-term engagement. The type(s) of user interactions preferably includes positive and/or negative indicators of long-term engagement. In one example, the model may utilize what a user has watched or launched after watching a particular content item as indicators. A user trajectory extracted for this model for a particular user may include a sequence of user interactions with different content items, e.g., including a sequence of content items the particular user has watched or launched on the platform over a long period of time.

Rewards for a particular content item can be calculated using the user trajectories. The model may use the indicators in the user trajectories to calculate rewards for a given content item. A user trajectory may include a long sequence of user interactions. For each user interaction in a user trajectory, referred to as a head user interaction, can have a window of user interactions that follow (e.g., occurred after) the user interaction in the long sequence of user interactions. A reward can be calculated for the head user interaction based on the window of user interactions that follows the head user interaction, e.g., a head user interaction with a particular content item. For a long sequence of user interactions, many rewards can be determined for different head user interactions with a sliding window. The window of user interactions specifies a predetermined number of user interactions that follow a user interaction in a sequence of user interactions. The size of the sliding window (e.g., the predetermined number) may be a parameter of the model.

For example, a reward can be calculated for a first head user interaction with a first content item by determining contributions (e.g., contribution values) of user interactions in the window that followed the first head user interaction. The reward may be a sum of contributions of the user interactions in the window. A contribution of a user interaction in the window may be discounted based on the amount of time between the user interaction and the first head user interaction (e.g., a position of the user interaction in the window). A contribution of a user interaction in the window may be set to a maximum contribution value if the user interaction is with the same or similar content item as the first content item. A machine learning model may be used to measure similarity or affinity between content items.

Rewards calculated in this manner for head user interactions with the particular content item can be aggregated as long-term engagement data for the particular content item. Rewards calculated in this manner for head user interactions with the particular content item can be aggregated as samples of a probability distribution representing how well the particular content item promotes long-term engagement for a population of users. An estimate for the engagement score for the particular content item can be determined from the aggregated rewards. For example, a lower confidence bound of the aggregated rewards may be used as the estimate of the engagement score for the particular content item.

The engagement scores of various content items can be used as part of candidate generation in a content item retrieval system. The engagement scores of various content items can be used as part of candidate ranking in a content item retrieval system.

The engagement scores of various content items can be used as part of candidate generation in a content item recommendation system. The engagement scores of various content items can be used as part of candidate selection/ranking in a content item recommendation system.

The engagement scores of various content items and metadata associated with the various content item can be used as training data to train a model that can make inferences on long-term engagement potential of a content item. Such a model can be used for making predictions on other content items. Such a model can be used in content acquisition decision making.

User trajectories can be extracted for users that belong to a specific demographic. User trajectories can be extracted based on user interactions that occurred within a context or user interactions associated with one or more contextual factors. Engagement scores calculated from such user trajectories can represent long-term engagement potential of content items specific to a demographic and/or one or more contextual factors.

Ability to determine and/or infer engagement scores of content items may enable the platform to better retain users and increase long-term engagement of users.

Various embodiments described herein relating to determining engagement scores from offline data can be extended to other scenarios besides long-term engagement with a digital content platform. The framework described herein can be extended to determining engagement scores for certain user interactions with a device (e.g., television, computer, tablet, mobile phone, application, Internet-of-Things device, home appliance, etc.). An engagement score may indicate how likely a certain user interaction would lead to more engagement and usage of the device (e.g., renewal of a subscription service for the device) in the future.

Depending on the period of time used in extracting the user trajectories, the engagement scores for various content items may change. Engagement scores may be updated or determined for several periods of time to identify content items which may promote long-term engagement during specific time periods.

Semantic and/or Contextual Content Item Search or Retrieval Systems

A digital content platform may allow users to access and view thousands to millions or more content items. Content items may include media content, such as audio content, video content, image content, augmented reality content, virtual reality content, mixed reality content, game, textual content, interactive content, etc. Examples of content items may include books, audio books, music, movies, television series, mini-series, advertisements, short films, films, documentaries, podcasts, audio clips, radio programming, games, interactive content, immersive content, etc.

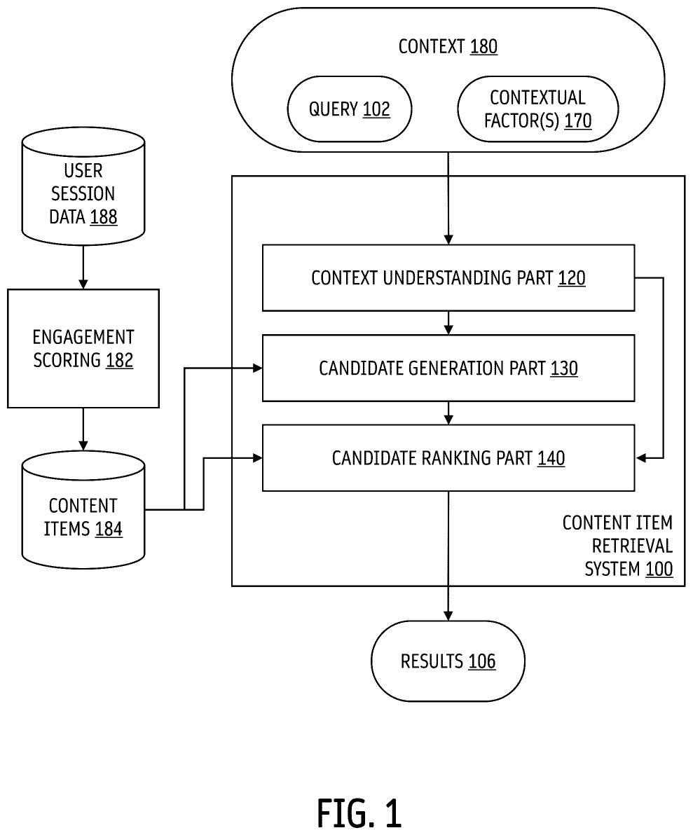

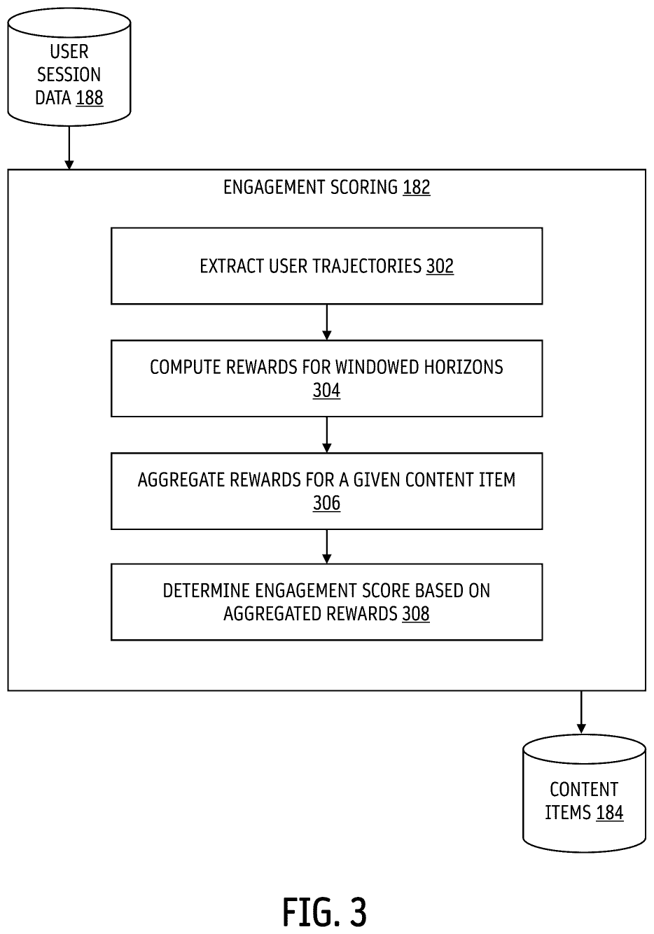

FIG. 1 illustrates a content item retrieval system that uses engagement scores, according to some embodiments of the disclosure. Engagement scoring 182 may use user session data 188 to determine engagement scores and store the engagement scores with content items 184. Details relating to engagement scoring 182 are described with FIGS. 3-7.

Users may routinely interact with a digital content platform by performing searches using the content item retrieval system. A search may begin with a query (e.g., query 102), and results 106 may be generated and output to the user. User interactions may be logged and stored in user session data 188.

Context 180 may be provided as input to content item retrieval system 100. Content item retrieval system 100 may include several operations. Content item retrieval system 100 may include one or more of: context understanding part 120, candidate generation part 130, and candidate ranking part 140. Content item retrieval system 100 may generate results 106.

Context 180 may capture context of a particular search session with a user. Context 180 may capture information that may be helpful for understanding what a user is looking for and/or what may be relevant or useful to the user. In some cases, context 180 may include query 102.

Query 102 may include natural language text and/or description provided by a user. Query 102 may include a natural language query. In some cases, query 102 may include a user-provided voice-based or text-based query to find content items. Examples of query 102 may include:
“Show me funny office comedies with romance”
“TV series with strong female characters”
“I want to watch 1980s romantic movies with a happy ending”
“Short animated film that talks about family values”
“Are there blockbuster movies from 1990s that involves a tragedy?”
“What is that movie where there is a Samoan warrior and a girl going on a sea adventure?
“What are some most critically-acclaimed dramas right now?”
“I want to see a film set in Tuscany but is not dubbed in English”
“Recommend me movies of Brad Pitt that are free for me to watch”

In some cases, context 180 may include query 102 and optionally one or more contextual factors 170. Examples of contextual factors 170 can include: characteristic(s) about the user making the query, time of day, day of the week, time of the year, seasonality (e.g., seasons, special events, holidays, etc.), one or more past queries made by the user, one or more past user interactivity information with the content platform (e.g., what the user clicked on, what the user has watched, etc.), whether the query is voice-based or text-based, the type of device that the user is using (e.g., mobile device versus television), the type of application that the user is using, whether the user is a paid subscriber or not, what subscriptions the user has, demographics about the user, whether the user is an expert/experienced user or not, whether the user is a loyal user or not, how many retrieved content items the user is looking for, characteristic(s) about the device the user is using to input the natural language query, the amount of bandwidth the user has on a network to receive content, the user's position in a social graph/network, the user's relationships with other users in a social graph/network, etc.

Context 180 may be provided as input to context understanding part 120. Context understanding part 120 may process context 180 to understand context 180, e.g., to extract contextual cues, semantic meaning, user intent, etc. In some cases, context understanding part 120 may implement a large language model. A prompt may be generated based on context 180, and the prompt may be used as input to the large language model. Context understanding part 120 may process context 180 (e.g., receive a prompt that has information about context 180 and an instruction having questions about context 180) and extract one or more attributes or other suitable information about context 180.

Based on information from context understanding part 120, candidate generation part 130 may search in content items 184 to determine relevant candidates to context 180. The one or more extracted attributes or other suitable information from context understanding part 120 may be provided to candidate generation part 130 to find semantically and/or contextually relevant candidates, e.g., content items in content items 184 that are semantically and/or contextually relevant to context 180. Candidate generation part 130 may find candidates in content items 184 that are semantically and/or contextually relevant to context 180. Candidate generation part 130 may use one or more models to identify a set of relevant candidates, e.g., content items relevant to context 180. Examples of models may include keyword matching, vector space model, probabilistic model, etc. One or more models may be used to score the candidates in content items 184 and determine relevance scores. Top K highest relevance scoring candidates may be returned as the set of relevant candidates. Relevant candidates may be provided to candidate ranking part 140 for ranking.

In some embodiments, engagement scores determined by engagement scoring 182 may impact operations in candidate generation part 130. For example, engagement scores may be used by candidate generation part 130 to determine relevance scores of the candidates. Engagement scores may be a component of the relevance score determined by candidate generation part 130. Content items with high-engagement scores may be scored higher by candidate generation part 130. In another example, engagement scores may be part of feature embeddings representing content items 184, and candidate generation part 130 may generate relevant scores for candidates using the feature embeddings. In another example, candidate generation part 130 may enforce a rule to include a predetermined number or proportion of relevant candidates in the top K highest relevance scoring candidates that have an engagement score over a threshold. In another example, candidate generation part 130 may use the engagement scores to create cohorts of content items having the same or similar engagement scores and enforce a rule to include a predetermined number of relevant candidates from each cohort.

Candidate ranking part 140 may rank the set of relevant candidates produced by candidate generation part 130. Candidate ranking part 140 may determine and output ranked candidates. Candidate ranking part 140 may determine a ranking score for each relevant candidate found by candidate generation part 130 and sort the relevant candidates based on the ranking scores to produce ranked relevant candidates. In some cases, candidate ranking part 140 may rank content items based on information from context understanding part 120. The one or more extracted attributes or other suitable information from context understanding part 120 may be provided to candidate ranking part 140 to augment ranking of relevant candidates, e.g., content items relevant to context 180.

In some embodiments, engagement scores determined by engagement scoring 182 may impact operations in candidate ranking part 140. For example, engagement scores may be used by candidate ranking part 140 to determine ranking scores of the candidates. Engagement scores may be a component of the ranking score determined by candidate ranking part 140. Content items with high-engagement scores may be scored higher or ranked higher by candidate ranking part 140. In another example, candidate ranking part 140 may enforce a rule to place relevant candidates that have an engagement score over a threshold in top N positions in the ranking. In another example, candidate ranking part 140 may signal one or more relevant candidates whose engagement scores are over a threshold. In another example, engagement scores may be used by candidate ranking part 140 to boost ranking scores of the relevant candidates. In some scenarios, relevant candidates with engagement scores above a threshold (e.g., indicating the relevant candidates are likely to promote long-term engagement) may be ranked lower due to context 180. However, it may be beneficial to rank the relevant candidates higher or place the relevant candidates in a higher position to encourage safe exploration and exposure to the relevant candidates with engagement scores above a threshold, or relevant candidates with relatively high-engagement scores. Candidate ranking part 140 may rank the relevant candidates based on a weighted sum of ranking scores and engagement scores. Candidate ranking part 140 may enforce a rule to ensure that at least the relevant candidate having a highest engagement score is in one of the top N positions in the ranking. In some cases, candidate ranking part 140 may decide randomly whether to boost ranking scores of relevant candidates based on the engagement scores.

Content item retrieval system 100 may return results 106 having ranked relevant candidates, e.g., content items relevant to context 180. Results 106 may be returned to the user who provided or input query 102. Results 106 may be output (e.g., rendered for display) to the user. Results 106 may be output to the user according to the ranking determined in candidate ranking part 140. In some cases, results 106 may be accentuated (e.g., enlarged) based on signaling from in candidate ranking part 140.

### Content Item Recommendation Systems

In some cases, one or more content items may be recommended to a user without involving a search. One or more content items may be recommended to a user when a user is using the digital content platform. One or more content items may be recommended to a user while the user is watching a content item. One or more content items may be recommended to a user when the user has just finished watching a content item. One or more content items may be recommended to a user when the user has interacted with a content item (e.g., liked, disliked, added to favorites, added to a watch later list, etc.).

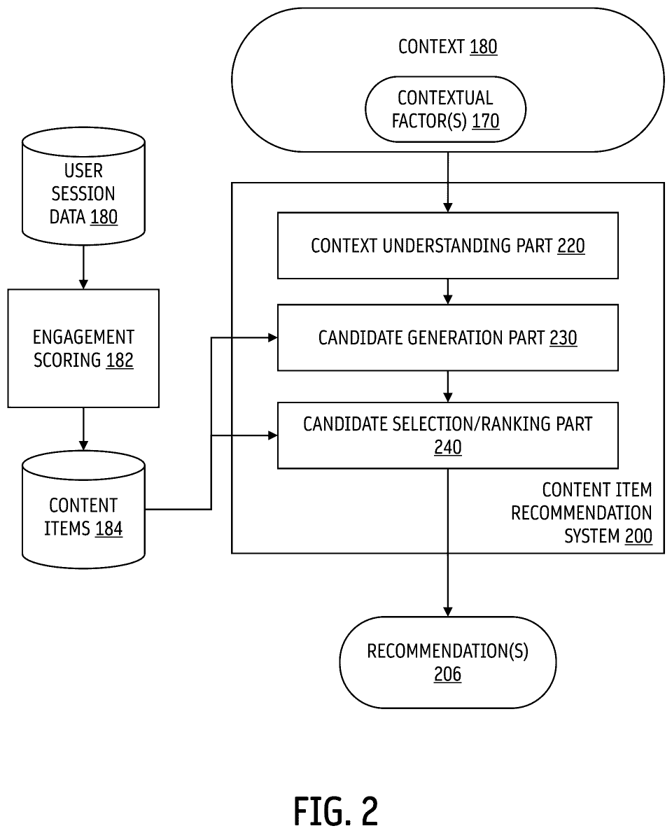

FIG. 2 illustrates a content item recommendation system that uses engagement scores, according to some embodiments of the disclosure. Users may routinely interact with content items recommended by a digital content platform. One or more recommendations 206 may be generated based on context 180. One or more recommendations 206 may be output to the user. User interactions may be logged and stored in user session data 188.

Context 180 may be provided as input to content item recommendation system 200. Content item recommendation system 200 may include several operations. Content item recommendation system 200 may include one or more of: context understanding part 220, candidate generation part 230, and candidate selection/ranking part 240. Content item recommendation system 200 may generate recommendations 206.

Context 180 may capture context of a particular session with a user. Context 180 may capture information that may be helpful for understanding the current context of the user and/or what may be relevant or useful to the user. Context 180 may include one or more contextual factors 170.

Context 180 may be provided as input to context understanding part 220. Context understanding part 120 may process context 180 to understand context 180, e.g., to extract contextual cues, user intent, etc. Context understanding part 220 may process one or more contextual factors 170 and extract one or more attributes or other suitable information about context 180.

Candidate generation part 230 may be implemented similarly to candidate generation part 130 of FIG. 1. In some embodiments, engagement scores determined by engagement scoring 182 may impact operations in candidate generation part 230. For example, engagement scores may be used by candidate generation part 230 to determine relevance scores of the candidates. Engagement scores may be a component of the relevance score determined by candidate generation part 230. Content items with high-engagement scores may be scored higher by candidate generation part 230. In another example, engagement scores may be part of feature embeddings representing content items 184, and candidate generation part 230 may generate relevant scores for candidates using the feature embeddings. In another example, candidate generation part 230 may enforce a rule to include a predetermined number or proportion of relevant candidates in the top K highest relevance scoring candidates that have an engagement score over a threshold.

Candidate selection/ranking part 240 may be implemented similarly to candidate ranking part 140 of FIG. 1. In practice, content item recommendation system 200 may produce one or more recommendations 206 (e.g., just one or two content items), whereas content item retrieval system 100 of FIG. 1 may produce several results 106 (e.g., a dozen content items). Candidate selection/ranking part 240 may be more selective when producing one or more recommendations 206 than candidate ranking part 140. Candidate selection/ranking part 240 may trim or filter out relevant candidates that do not meet one or more criteria.

In some embodiments, engagement scores determined by engagement scoring 182 may impact operations in candidate selection/ranking part 240. For example, engagement scores may be used by candidate selection/ranking part 240 to determine ranking scores of the candidates. Engagement scores may be a component of the ranking score determined by candidate selection/ranking part 240. Content items with high-engagement scores may be scored higher or ranked higher by candidate selection/ranking part 240. In another example, candidate selection/ranking part 240 may enforce a rule to rank and return a number of relevant candidates that have an engagement score over a threshold. In another example, candidate selection/ranking part 240 may enforce a rule to return a relevant candidate that has a highest engagement score. In another example, candidate selection/ranking part 240 may enforce a rule to return two relevant candidates that have the highest engagement scores. In another example, candidate selection/ranking part 240 may signal one or more relevant candidates that engagement scores over a threshold. In another example, engagement scores may be used by candidate selection/ranking part 240 to boost ranking scores of the relevant candidates. In some scenarios, relevant candidates with engagement scores above a threshold (e.g., indicating the relevant candidates are likely to promote long-term engagement) may be ranked lower due to context 180. However, it may be beneficial to rank the relevant candidates higher or place the relevant candidates in a higher position to encourage safe exploration and exposure to the relevant candidates with engagement scores above a threshold, or relevant candidates with relatively high-engagement scores. Candidate selection/ranking part 240 may rank the relevant candidates based on a weighted sum of ranking scores and engagement scores. Candidate selection/ranking part 240 may enforce a rule to ensure that at least the relevant candidate having the highest engagement score is in one of the top N positions in the ranking. In some cases, candidate selection/ranking part 240 may decide randomly whether to boost ranking scores of relevant candidates based on the engagement scores.

Content item recommendation system 200 may return one or more recommendations 206 having (ranked) relevant candidates, e.g., recommended content items relevant to context 180. One or more recommendations 206 may be returned to the user. One or more recommendations 206 may be output (e.g., rendered for display) to the user. One or more recommendations 206 may be output to the user according to the selection/ranking determined in candidate selection/ranking part 240. In some cases, one or more recommendations 206 may be accentuated (e.g., enlarged) based on signaling from in candidate selection/ranking part 240.

### Engagement Scoring and Long-Term Engagement Modeling

FIG. 3 illustrates engagement scoring 182 based on user session data, according to some embodiments of the disclosure. Engagement scoring 182 may receive user session data 188. Engagement scoring 182 may output engagement scores to be stored with content items 184. Engagement scoring 182 may include one or more operations, such as extract user trajectories 302, compute rewards for windowed horizons 304, aggregate rewards for a given content item 306, and determine engagement score based on aggregated rewards 308.

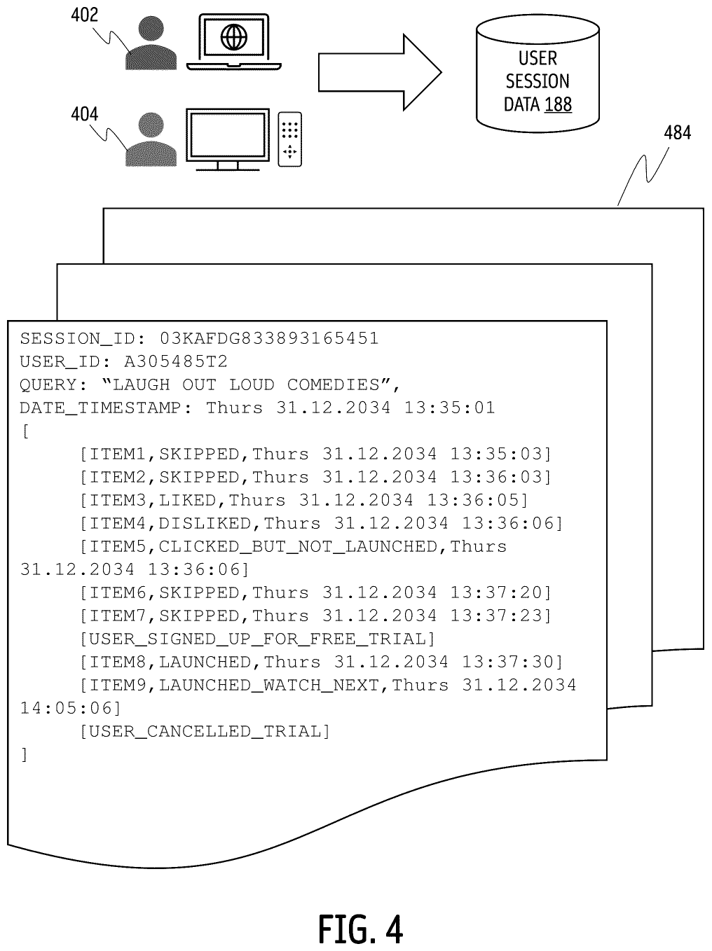

In extract user trajectories 302, user session data 188 may be processed to produce user trajectories. FIG. 4 provides an illustration of user session data 188. A user trajectory includes a user's interactions on the platform over a period of time, which may be stored in user session data 188. A user trajectory may include a sequence of user interactions, such as user interactions with content items, on the platform associated with a particular user over a period of time. A first user trajectory may include a first sequence of user interactions (e.g., user interactions with content items) on the platform associated with a first user over the period of time. A second user trajectory may include a second (different) sequence of user interactions (e.g., user interactions with content items) on the platform associated with a second user over the period of time. The period of time may be long, such as 7 days or longer, 30 days or longer, 60 days or longer, or 90 days or longer to capture user interactions spanning a long period of time.

User trajectories may include one or more specific types of user interactions, such as one or more types of user interactions which may be indicators of long-term engagement. A model for long-term engagement may specify one or more indicators and can specify how to determine a reward based on the one or more indicators. In other words, the model for long-term engagement may use the one or more indicators to determine whether a content item is likely to promote or caused long-term engagement. Different indicators may contribute to the reward differently. Indicators may include positive indicators that suggest long-term engagement. Positive indicators may contribute positively to the reward. Indicators may include negative indicators that suggest disengagement. Negative indicators may contribute negatively to the reward.

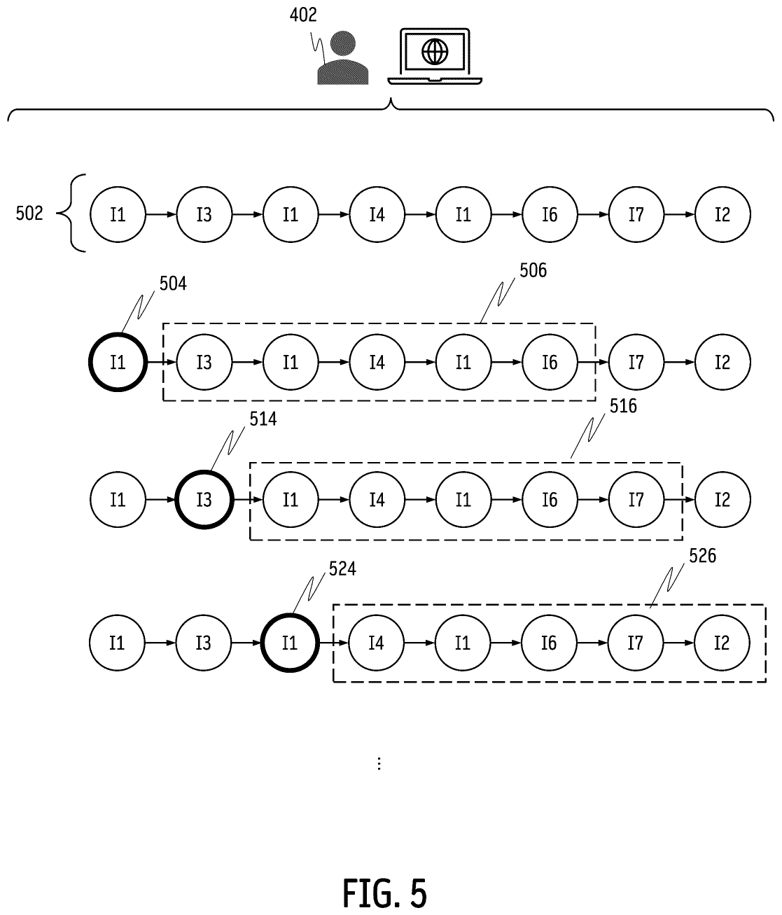

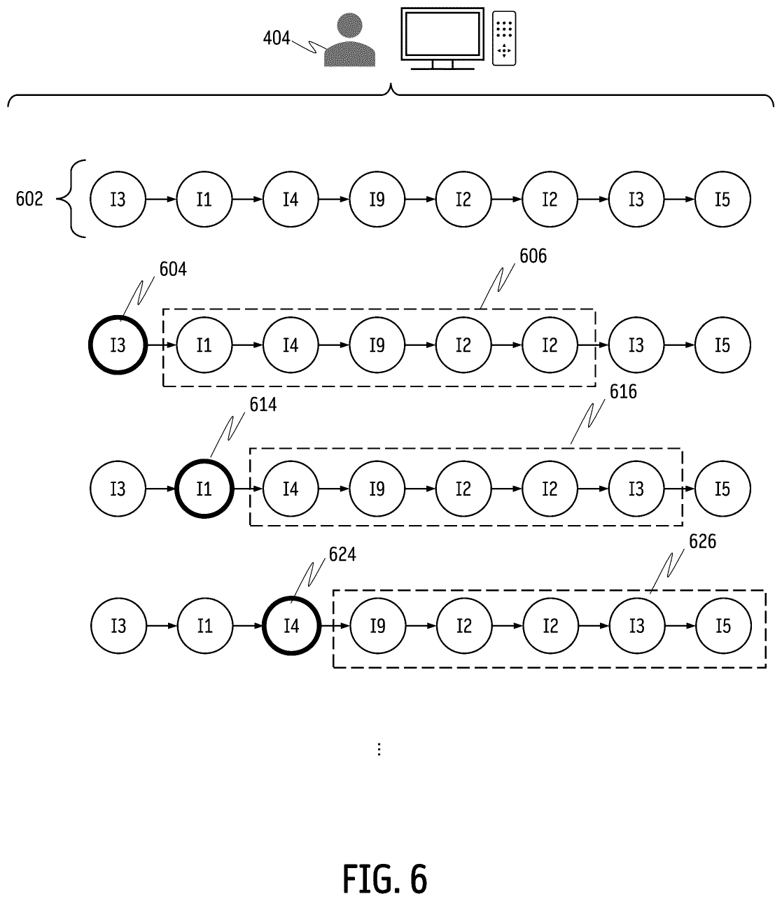

In some embodiments, the model for long-term engagement may use watch histories of search users in the last D number of days as indicators for long-term engagement. The model may be based on a hypothesis that different search sessions of a given user is not purely independently and identically distributed. Rather, user interactions in past search sessions many search sessions may contribute to user trust and the user's potential revisits to the platform. Additionally, certain content items may contribute to more to revisits (e.g., through “continue watching”) due to binge-ability or high replay-ability of the content items. In extract user trajectories 302, user session data 188 may be processed to produce user trajectories, where a user trajectory may include a sequence of content items watched by a user on the platform. A first user trajectory may include a first sequence of content items watched by a first user on the platform over a period of time. A second user trajectory may include a second sequence of content items watched by a second user on the platform over a period of time. FIGS. 5-6 illustrate examples of the first user trajectory and the second user trajectory.

In some embodiments, the model for long-term engagement may be based on one or more other types of indicators or other hypotheses. In some embodiments, the model may be replaced by a model that increases revenue (e.g., cause/trigger renewal of subscription within a number of days). In some embodiments, the model may be replaced by a model that increases active time on the platform. In some embodiments, the model may be replaced by a model that increases number of sessions on the platform within a number of days.

In extract user trajectories 302, user session data 188 may be processed to produce user trajectories, where a user trajectory may include a sequence of user interactions associated with a user on the platform. The user interactions may include one or more types of user interactions. The types of user interactions included in user trajectories may depend on the model. Exemplary types of user interactions may include:
User skipped a content item
User liked a content item
User disliked a content item
User clicked but did not launch/watch a content item
User signed up for a free trial
User cancelled the free trial
User watched a content item
User fast forwarded through a content item
User did not finish a content item (e.g., tuned out)
User only watched a first portion of a content item
User watched a content item because the user clicked on “continue watching” or “watch next”
User signed up for a fee-based subscription
User cancelled the fee-based subscription
User added content item to favorites
User added content item to “watch later”

In compute rewards for windowed horizons 304, user trajectories can be used as a data set for calculating rewards. Within a user trajectory, each user interaction in the sequence of user interactions can be considered an anchor or head, which may have an influence a window or horizon of user interactions that follow the anchor or head. The user interactions in the window or horizon can be used as indicators to measure the influence the anchor or head has on the user interactions that follow. The size of the window or horizon may be a parameter that specifies a fixed number of user interactions that follow the anchor or head. In some cases, the size of the window or horizon may be a parameter that specifies a period of time from the timestamp of the anchor or head.

For a first user interaction in the sequence, it is possible to compute a first potential reward accumulated after the first user interaction based on the user interactions in the window or horizon that followed the first user interaction. Compute rewards for windowed horizons 304 may compute a first reward for a first user interaction with a particular content item in the first sequence (of user interactions in a first user trajectory) based on a window of user interactions with content items that follow the first user interaction in the first sequence.

For a second user interaction in the sequence, it is possible to compute a second potential reward accumulated after the second user interaction based on the user interactions in the window or horizon that followed the second user interaction. Compute rewards for windowed horizons 304 may compute a second reward for a second user interaction with the particular content item in a second sequence (of user interactions in a second user trajectory) based on a window of user interactions with content items that follow the second user interaction in the second sequence.

The window or horizon can move along the user trajectory like a sliding window to compute rewards for different user interactions (e.g., user interactions with various content items) in the user trajectory. In some embodiments, the window or horizon may specify a predetermined number of user interactions that follow a user interaction in a sequence of user interactions. FIGS. 5-6 illustrate calculating rewards using the first user trajectory and the second user trajectory.

In some embodiments, compute rewards for windowed horizons 304 uses the user interactions in the window or horizon to calculate a reward for a given head/anchor user interaction in the sequence. For example, compute rewards for windowed horizons 304 may determine a contribution value for each user interaction (e.g., each user interaction with a content item) in the window. Compute rewards for windowed horizon 304 may combine the contribution values in a suitable manner to compute the reward for the head/anchor user interaction. The reward may measure the influence the head/anchor user interaction (e.g., user interaction with a particular content item) has on the user interactions (e.g., user interactions with content items) in the window or horizon.

An exemplary algorithm for computing a reward (“REWARD”) for a given content item associated with a head/anchor user interaction in the sequence (“HEAD”), a size of the window or horizon (“WINDOW_SIZE”), content items associated with user interactions in the window or horizon (“TAIL[i]”), and a decay factor (“TRUST_DECAY_FACTOR”) is illustrated by the following pseudocode:

```
Initialize REWARD=0 //REWARD is an accumulator
Iterate over i in TAIL[i]: //from 0 to WINDOW_SIZE-1
  If (TAIL[i]==HEAD OR similarity(TAIL[i],HEAD)> THRESHOLD)
    Set REWARD+=1 //add max contribution value of 1 to REWARD
  Else:
    Set REWARD+= TRUST_DECAY_FACTOR ** (i+1) //add
    trust_decay_factor to the (i+1)th power to REWARD
```

In some embodiments, such as an embodiment illustrated by the pseudocode above, accumulates or sums contribution values determined for the content items associated with user interactions in the window (e.g., “TAIL[i]” for all i).

The contribution value being added to the reward may be determined based on a relationship between a content item associated with the head/anchor user interaction (“HEAD”) and a particular content item associated with a user interaction in the window (“TAIL[i]” for a particular i). The relationship may include whether the content item associated with the head/anchor user interaction (“HEAD”) is the same as the particular content item in the window (“TAIL[i]” for a particular i). The relationship may include how similar the content item associated with the head/anchor user interaction (“HEAD”) is to the particular content item in the window (“TAIL[i]” for a particular i). The relationship may include how far apart the head/anchor user interaction in the sequence (“HEAD”) and the user interaction in the window (“TAIL[i]” for a particular i) are in time, position, or distance. The contribution value may be set relatively higher when the relationship indicates long-term engagement, and the contribution value may be set relatively lower when the relationship does not indicate long-term engagement. The contribution value may decay (e.g., linearly or exponentially) according to how far apart the head/anchor user interaction in the sequence (“HEAD”) and the user interaction in the window (“TAIL[i]” for a particular i) are in time, position, or distance.

In the pseudocode above, “TAIL[i]==HEAD” may be denote determining whether the content item associated with the head/anchor user interaction (“HEAD”) is the same as the particular content item associated with the user interaction in the window (“TAIL[i]” for a particular i). The user may have re-watched the same content item again. In response to determining that the content item associated with the head/anchor user interaction is the same as the particular content item associated with the user interaction in the window, the contribution value of for the particular content item associated with the user interaction in the window (“TAIL[i]” for a particular i) may be set to the maximum contribution value. In the example shown, the maximum contribution value is 1. The contribution value of 1 may be added to the reward (“REWARD”). It is envisioned that other values may be used.

In the pseudocode above, “similarity (TAIL[i],HEAD)>THRESHOLD” may denote determining whether an affinity or similarity between the content item associated with the head/anchor user interaction (“HEAD”) and the particular content item associated with the user interaction in the window (“TAIL[i]” for a particular i) crosses a threshold. The user may have watched a similar content item, or a content item in the same franchise or series. In response to determining the affinity or similarity crosses a threshold, the contribution value of for the particular content item associated with the user interaction in the window (“TAIL[i]” for a particular i) may be set to a maximum contribution value. In the example shown, the maximum contribution value is 1. The contribution value of 1 may be added to the reward (“REWARD”). It is envisioned that other values may be used.

In some embodiments, affinity or similarity of two content items (e.g., “similarity (TAIL[i],HEAD)”) can be determined using a suitable technique. For example, the affinity or similarity may be determined based on distance between a first embedding generated by a model based on first metadata of a first content item and a second embedding generated by the model based on second metadata of a second content item. The distance may be based on cosine similarity, Euclidean distance, Manhattan distance, dot product, learned similarity measures, kernelized similarity, etc. The model may be a neural network based machine learning model. The model may be a transformer-based machine learning model. The model may measure semantic affinity. The model may measure collaborative similarity. The model may measure keyword similarity.

Metadata of a content item may include one or more of: plot line, synopsis, director, list of actors, list of artists, list of athletes/teams, list of writers, list of characters, length of content item, language of content item, country of origin of content item, genre, category, tags, presence of advertising content, viewers' ratings, critic's ratings, parental ratings, production company, release date, release year, platform on which the content item is released, whether it is part of a franchise or series, type of content item, sports scores, viewership, popularity score, minority group diversity rating, audio channel information, availability of subtitles, beats per minute, list of filming locations, list of awards, list of award nominations, seasonality information, etc.

In the pseudocode above, “else” statement may be cases where the content item associated with the head/anchor user interaction (“HEAD”) and the particular content item associated with the user interaction in the window (“TAIL[i]” for a particular i) are not the same and not similar. The user did not rewatch the content item or watch a similar/related content item. In response to determining that the content item associated with the head/anchor user interaction and the particular content item associated with the user interaction in the window are not the same and not similar, the contribution value of for the particular content item associated with the user interaction in the window (“TAIL[i]” for a particular i) may be set based on a position of the user interaction with the particular content item in the window (e.g., i in “TAIL[i]”). In the example shown, the contribution value is set based on a decay factor (e.g., “TRUST_DECAY_FACTOR”) and the index i (which indicates a distance of the user interaction with the particular content item in the window with the head/anchor user interaction). Specifically, the contribution value is set based on the decay factor having an exponent of i+1. The decay factor is less than 1, and i may have a range from 0 to WINDOW_SIZE−1. The contribution value may decay as the position or distance increases. In some embodiments, the decay in the contribution value as the position or distance increases is based on the Bellaman equation. It is envisioned that other decay factors and/or decaying functions may be used. The contribution value set according to the decay factor and the index i may be added to the reward (“REWARD”).

The pseudocode example above illustrates a model where for every content item in the window or horizon that is not equal or similar to the content item of the head/anchor user interaction, the contribution towards the reward decreases as the gap between the head/anchor user interaction and the content item in the window increases. If the content item in the window is the same or similar to the head item, the contribution towards the reward is set to be the maximum contribution. The model can attribute the user interaction associated with the user watching the same or similar content item in the future as being caused or influenced by the head/anchor user interaction. For example, if a user watches a second episode of a television series in the window or horizon after watching the first episode of the television series, the contribution of the user watching the second episode of the television series is set to be the maximum contribution. In another example, if a user watches a related/similar movie after watching a movie, the contribution of the user watching the related/similar movie is set to be the maximum contribution.

The pseudocode example illustrates calculating a reward based on a model whose goal is to maximize contribution to the reward when a user interaction with a content item leads to long-term engagement with the platform and lower contribution to the reward when a user interaction does not lead to long-term engagement. It is envisioned by the disclosure that other methodologies can be implemented to calculate a reward. The methodology for a model with a particular goal would be tailored to maximize contribution to the reward when a user interaction achieves the goal and to lower contribution to the reward when a user interaction does not achieve the goal. In some cases, the methodology may evaluate individual contributions of user interactions in the window or horizon and combine the individual contributions to form the reward. In some cases, the methodology may evaluate a collective contribution of user interactions in the window or horizon (e.g., taking into counts or proportion of a certain type of user interaction), and use the collective contribution as part of the reward.

In some embodiments, the user trajectories may include other types of user interactions. If a particular user interaction in the window is a positive indicator for the goal of the model, the contribution value may be set to a positive value. If a particular user interaction in the window is a negative indicator for the goal of the model, the contribution value may be set to a negative value. Different types of user interactions may have different contribution values, or contribute to the reward differently, depending on the goal of the model. The contribution value may decay when the gap between the head/anchor user interaction and the particular user interaction widens.

In aggregate rewards for a given content item 306, rewards computed for a particular content item using the user trajectories, e.g., rewards computed where a head/anchor user interaction is associated with the particular content item, may be collected, collated, or aggregated. Aggregate rewards for a given content item 306 may examine and collect rewards computed where the given content item is associated with the head/anchor user interaction as data or samples. The data or samples may reveal how likely the given content item is going to promote long-term engagement for a population of users. Aggregate rewards for a given content item 306 may aggregate rewards computed for other content items using the user trajectories.

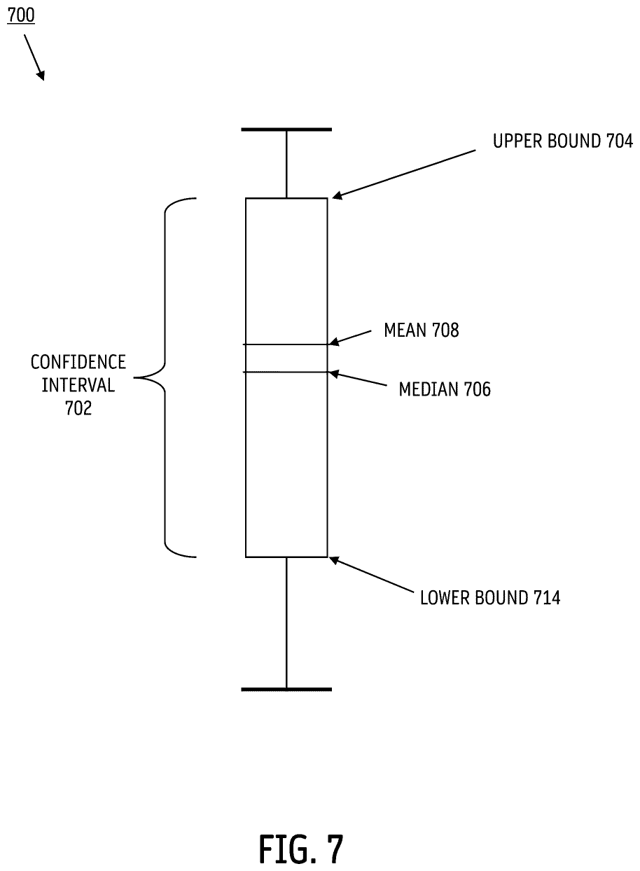

In determine engagement score based on aggregated rewards 308, an engagement score for the given content item can be determined based on the rewards computed for the given content item. When working with offline user session data 188, the aggregated rewards may not fully represent the entire population of users and for all content items in content items 184 and may have uncertainty. The rewards may form a probability distribution, or a statistical distribution for a population of users, where the distribution may have uncertainty. FIG. 7 illustrates an example of the distribution. An engagement score may be determined using entropy regularization, to avoid overfitting the model to the rewards and to account for the uncertainty. An engagement score may be determined based on a probability distribution formed using the aggregated rewards computed for a given content item. An engagement score may include an expectation or estimate of reward for the given content item based on the aggregated rewards. The engagement score may be determined based on the variance of the distribution. The engagement score may be determined based on a mean of the distribution. The engagement score may be determined based on a mode of the distribution. The engagement scores may be determined based on a distribution of rewards with tail rewards (from niche users or outliers) removed. The engagement score may be determined in a manner to ensure that the engagement score does not overfit to statistically unlikely or inconsistent rewards. The engagement score may be determined in a manner to ensure that the engagement score does not overfit to rewards that sparsely sample the population of users (e.g., accounts for high uncertainty). In some embodiments, an entropy-based model with a regularization term accounting for the uncertainty may be used to capture the probability distribution formed using the aggregated rewards. In some embodiments, a Thompson-sampling based model accounting for the uncertainty may be used to capture the probability distribution formed using the aggregated rewards. In some embodiments, a Markov Chain Monte Carlo model accounting for the uncertainty may be used to capture the probability distribution formed using the aggregated rewards. In some embodiments, an importance sampling model accounting for the uncertainty may be used to capture the probability distribution formed using the aggregated rewards. In some embodiments, a rejection sampling model accounting for the uncertainty may be used to capture the probability distribution formed using the aggregated rewards.

In some cases, an engagement score may be determined based on a lower confidence bound (LCB) of a distribution formed using the aggregated rewards computed for the given content item. A lower confidence bound is a conservative estimate (e.g., accounting for a high amount of uncertainty and discounts sparsely occurring rewards), which may better capture the uncertainty in the aggregated rewards. A lower confidence bound may exploit on content items that are proven to be more reward generating. A lower confidence bound may be calculated based on the following equation:

$$L C B = {Q}_{t} ( a ) - c \sqrt{\frac{log {N}_{TOTAL}}{{N}_{WITH \_ HEAD}}} \qquad ( equation 1 )$$

Qₜ(a) may be the average of rewards aggregated for a particular content item. N_{TOTAL} may be a total number of user trajectories (e.g., extract user trajectories 302). N_{IS_HEAD} may be a total number of rewards calculated (or total number of windows/horizons examined) where the particular content item is associated with the head/anchor user interaction in the sequence of user interactions. c may be a factor of exploration.

In some embodiments, determine engagement score based on aggregated rewards 308 may not determine an engagement score if N_{IS_HEAD} is too small (e.g., too few samples). In some embodiments, determine engagement score based on aggregated rewards 308 may not determine an engagement score if N_{IS_HEAD}/N_{TOTAL} is too small (e.g., too few samples).

In some embodiments, the engagement score may include one or more numerical values. The engagement score may include a numerical value that quantifies the likelihood that a content item would promote long-term engagement (relative to other content items). The engagement score may include a confidence value that quantifies how confident the numerical value is. The confidence value may be determined based on one or more characteristics of the rewards distribution from which the numerical value is determined.

In some embodiments, the user trajectories extracted by extract user trajectories 302 may be based on a particular demographic of users. The rewards calculated from the user trajectories may be conditioned on the particular demographic of users to reflect content items' likelihood to promote long-term engagement with the particular demographic of users.

In some embodiments, the user trajectories extracted by extract user trajectories 302 may be associated with one or more contextual factors. The rewards calculated from the user trajectories may be conditioned on the one or more contextual factors to reflect content items' likelihood to promote long-term engagement under those contextual factors.

FIG. 4 illustrates exemplary user session data 188, according to some embodiments of the disclosure. User session data 188 may include logs of user interactions of users on the platform, such as user 402 and user 404. User session data 188 may include many entries, such as entry 484. Entry 484 may include a session identifier (“SESSION_ID”) that uniquely identifies a user's session on the platform. A user may have many sessions on the platform. Entry 484 may include a user identifier (“USER_ID”) that uniquely identifies the user. Entry 484 may include a query input by the user (“QUERY”). Entry 484 may include one or more contextual factors (e.g., time of day, date, day of the week, etc.). For example, entry 484 may include a date timestamp (“DATE_TIMESTAMP”). Entry 484 may include a log of user interactions of various types and a timestamp associated with the user interactions. A user interaction may be of a specific type of user interaction (e.g., SKIPPED, LIKED, DISLIKED, CLICKED_BUT_NOT_LAUNCHED, USER_SIGNED_UP_FOR_FREE_TRIAL, LAUNCHED, LAUNCHED_WATCH_NEXT, etc.). A user interaction may be associated with a content item (e.g., ITEM1, ITEM2, ITEM3, etc.).

FIG. 5 illustrates an exemplary user trajectory 502 and rewards calculated based on the user trajectory, according to some embodiments of the disclosure. User trajectory 502 may represent a sequence of user interactions by user 402 on a platform over a period of time. User trajectory 502 may include a sequence of user interactions comprising: a first user interaction with content item I1, a second user interaction with content item I3, a third user interaction with content item I1, a fourth user interaction with content item I4, a fifth user interaction with content item I1, a sixth user interaction with content item I6, a seventh user interaction with content item I7, and an eighth user interaction with content item I2.

To calculate a reward for content item I1, a first user interaction with content item I1 is set as the head/anchor user interaction 504, and a window 506 of user interactions that follow the head/anchor user interaction 504 is examined. The window 506 may include 5 user interactions as shown. The reward for content item I1 may be calculated based on the window 506 of user interactions, e.g., a second user interaction with content item I3, a third user interaction with content item I1, a fourth user interaction with content item I4, a fifth user interaction with content item I1, and a sixth user interaction with content item I6. Contribution values and the reward may be determined based on window 506 of user interactions in a manner described and illustrated with FIG. 3.

To calculate a reward for content item I3, a second user interaction with content item I3 is set as the head/anchor user interaction 514, and a window 516 of user interactions that follow the head/anchor user interaction 514 is examined. The window 516 may include 5 user interactions as shown and slide down the sequence of user interactions. The reward for content item I3 may be calculated based on the window 516 of user interactions, e.g., a third user interaction with content item I1, a fourth user interaction with content item I4, a fifth user interaction with content item I1, a sixth user interaction with content item I6, and a seventh user interaction with content item I7. Contribution values and the reward may be determined based on window 516 of user interactions in a manner described and illustrated with FIG. 3.

To calculate a reward for content item I1, a third user interaction with content item I1 is set as the head/anchor user interaction 524, and a window 526 of user interactions that follow the head/anchor user interaction 524 is examined. The window 526 may include 5 user interactions as shown and slide down the sequence of user interactions. The reward for content item I1 may be calculated based on the window 526 of user interactions, e.g., a fourth user interaction with content item I4, a fifth user interaction with content item I1, a sixth user interaction with content item I6, a seventh user interaction with content item I7, and an eighth user interaction with content item I2. Contribution values and the reward may be determined based on window 526 of user interactions in a manner described and illustrated with FIG. 3.

FIG. 6 illustrates another exemplary user trajectory and rewards calculated based on the user trajectory, according to some embodiments of the disclosure. User trajectory 602 may represent a sequence of user interactions by user 404 on a platform over a period of time. User trajectory 602 may include a sequence of user interactions comprising: a first user interaction with content item I3, a second user interaction with content item I1, a third user interaction with content item I4, a fourth user interaction with content item I9, a fifth user interaction with content item I2, a sixth user interaction with content item I2, a seventh user interaction with content item I3, and an eighth user interaction with content item I5.

To calculate a reward for content item I3, a first user interaction with content item I3 is set as the head/anchor user interaction 604, and a window 606 of user interactions that follow the head/anchor user interaction 604 is examined. The window 606 may include 5 user interactions as shown. The reward for content item I3 may be calculated based on the window 606 of user interactions, e.g., a second user interaction with content item I2, a third user interaction with content item I4, a fourth user interaction with content item I9, a fifth user interaction with content item I2, and a sixth user interaction with content item I2. Contribution values and the reward may be determined based on window 606 of user interactions in a manner described and illustrated with FIG. 3.

To calculate a reward for content item I1, a second user interaction with content item I1 is set as the head/anchor user interaction 614, and a window 616 of user interactions that follow the head/anchor user interaction 614 is examined. The window 616 may include 5 user interactions as shown and slide down the sequence of user interactions. The reward for content item I1 may be calculated based on the window 616 of user interactions, e.g., a third user interaction with content item I4, a fourth user interaction with content item I9, a fifth user interaction with content item I2, a sixth user interaction with content item I2, and a seventh user interaction with content item I3. Contribution values and the reward may be determined based on window 616 of user interactions in a manner described and illustrated with FIG. 3.

To calculate a reward for content item I4, a third user interaction with content item I4 is set as the head/anchor user interaction 624, and a window 626 of user interactions that follow the head/anchor user interaction 624 is examined. The window 626 may include 5 user interactions as shown and slide down the sequence of user interactions. The reward for content item I4 may be calculated based on the window 626 of user interactions, e.g., a fourth user interaction with content item I9, a fifth user interaction with content item I2, a sixth user interaction with content item I2, a seventh user interaction with content item I3, and an eighth user interaction with content item I5. Contribution values and the reward may be determined based on window 626 of user interactions in a manner described and illustrated with FIG. 3.

As illustrated in FIGS. 5-6, rewards for various content items may be calculated. Multiple rewards for the same content item may be aggregated. Reward for a particular content item may be aggregated with other rewards computed for the same content item.

FIG. 7 illustrates a box plot 700 of a probability distribution formed from the rewards, according to some embodiments of the disclosure. The aggregated rewards may form a distribution having the box plot 700. The distribution may have a mean 708 and median 706. The engagement score determined from the aggregated rewards may be based on mean 708. The engagement score determined from the aggregated rewards may be based on median 706. In some cases, the distribution may have a confidence interval 702. The confidence interval 702 may depend on the amount of uncertainty in the distribution (e.g., number of samples relative to a total number of samples, variance, standard deviation, etc.). Confidence interval 702 may have an upper bound 704, which may correspond to an upper confidence bound of the distribution. Confidence interval 702 may have a lower bound 714, which may correspond to a lower confidence bound of the distribution (e.g., such as LCB calculated using equation 1). Confidence interval 702 may have a corresponding confidence level, which is a percentage of times an estimate for the engagement score would fall between upper bound 704 and lower bound 714.

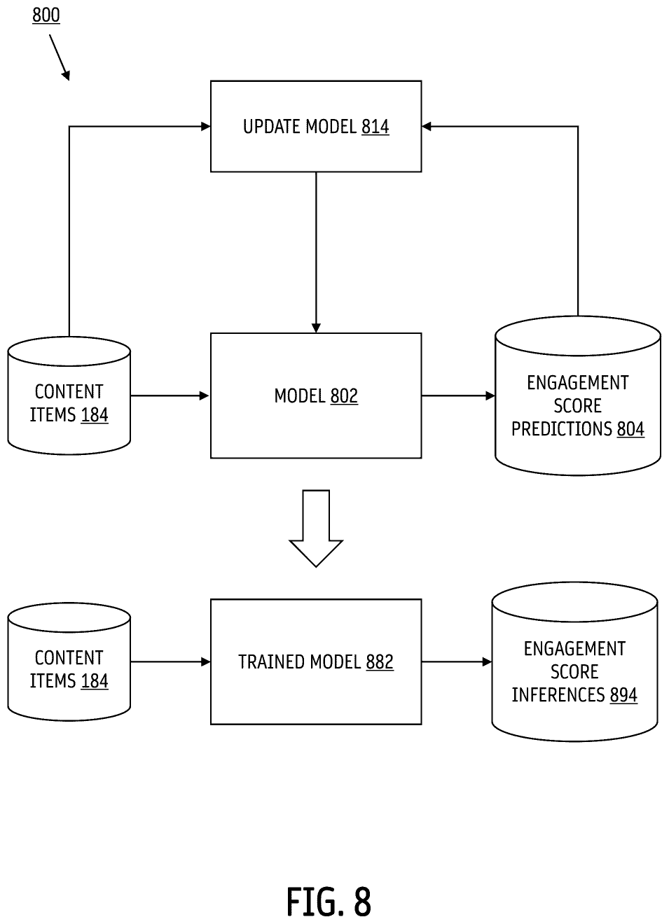

FIG. 8 illustrates training a model using content items and their corresponding engagement scores, according to some embodiments of the disclosure. System 800 is depicted. Engagement scores determined using the techniques described herein can be stored with content items in content items 184. The content items and their corresponding engagement scores can be used as training data to train model 802. Model 802 may receive at least metadata of a content item or other data that represents the content item as input and output/predict an engagement score for the content item based on the input. During training, model 802 may receive data that represents the content item as input from content items 184 and produce engagement score predictions 804. Update model 814 may compare the engagement score predictions 804 against the engagement scores determined using the techniques described herein, and use the comparison (e.g., compute one or more errors) to update one or more parameters of model 802. The one or more parameters of model 802 may be updated by update model 814 in a manner to improve the prediction performance of model 802 (e.g., to reduce the error(s)). Update model 814 may find values for the one or more parameters of model 802 that minimizes a loss function, which may include one or more errors.

In some embodiments, engagement scores may be determined using user trajectories associated with a certain demographic, and/or with one or more contextual factors. Features regarding the certain demographic and/or the one or more contextual factors may also be used by update model 814 as part of training data (e.g., as part of an input feature vector) to update parameters of model 802 to learn to predict engagement scores conditioned on or based on the demographic and/or the one or more contextual factors.

Once trained, trained model 882 may be used to process data that represent a content item from content items 184 (e.g., a content item which did not show up in the user trajectories, a content item which did not have a sufficient number of rewards calculated, a new content item, etc.), and output/predict engagement score inferences 894. Trained model 882 may be able to understand content items in a feature vector space and infer whether certain features of a content item is likely going to promote long-term engagement on the platform. The predictions can be used as engagement scores, which may be used in content item retrieval system 100 of FIG. 1 and/or content item recommendation system 200 of FIG. 2. The predictions may be used for content acquisition decision making. The predictions may be used for content generation to optimize generating content that promotes long-term engagement.

### Exemplary Method for Determining Engagement Scores

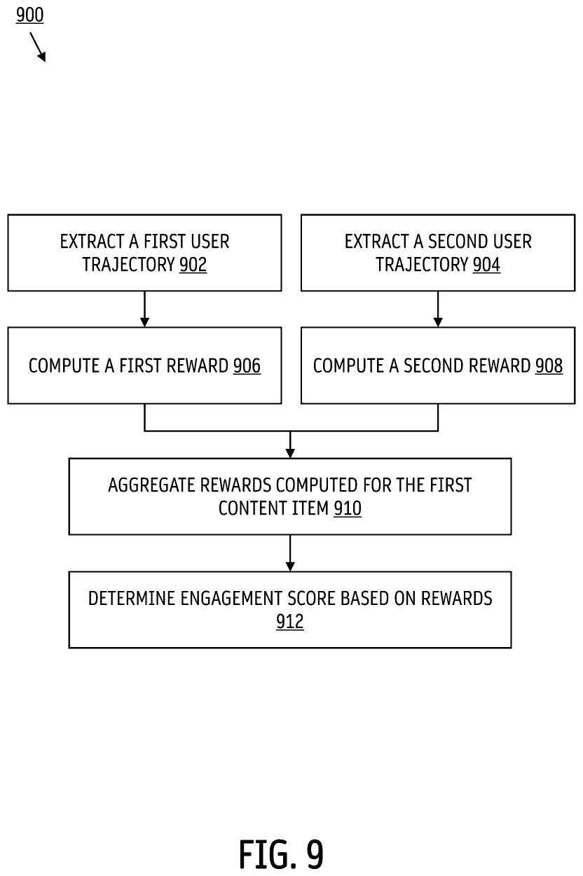

FIG. 9 is a flow chart illustrating a method 900 for determining engagement scores, according to some embodiments of the disclosure. Method 900 may be carried out by engagement scoring 182 of the FIGS.

In 902, a first user trajectory may be extracted. The first user trajectory may include a first sequence of user interactions with content items on a platform associated with a first user over a period of time.

In 904, a second user trajectory may be extracted. The second user trajectory may include a second sequence of user interactions with content items on the platform associated with a second user over the period of time.

In 906, a first reward for a first user interaction with a first content item in the first sequence may be computed. The first reward may be computed based on a window of user interactions with content items that follow the first user interaction in the first sequence.

In 908, a second reward for a second user interaction with the first content item in the second sequence may be computed. The second reward may be computed based on the window of user interactions with content items that follow the second user interaction in the second sequence.

In 910, rewards computed for the first content item may be aggregated. The rewards can include the first reward and the second reward.

In 912, a first engagement score for the first content item may be determined based on the rewards computed for the first content item.

### Exemplary Method for Outputting One or More Content Items Based on the Engagement Scores

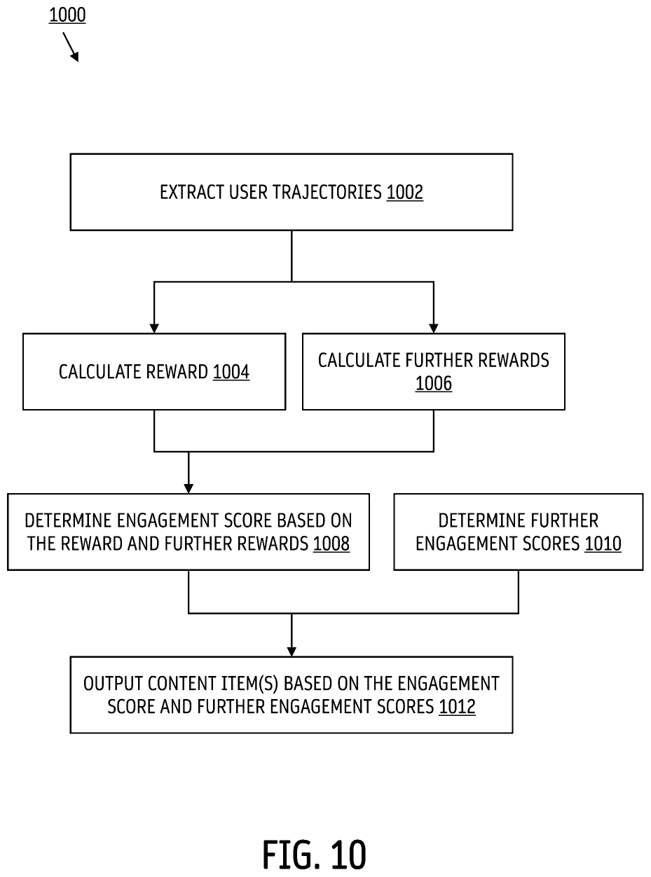

FIG. 10 is a flow chart illustrating a method 1000 for outputting one or more content items based on the engagement scores, according to some embodiments of the disclosure. Method 1000 may be carried out by engagement scoring 182 of the FIGS., content item retrieval system 100 of FIG. 1, and/or content item recommendation system 200 of FIG. 2.

In 1002, user trajectories may be extracted based on past user session data on a platform. A first user trajectory in the user trajectories can include a sequence of user interactions on the platform associated with a user over a period of time. A second user trajectory in the user trajectories can include a sequence of user interactions on the platform associated with a different user over the period of time.

In 1004, for a first user interaction with a first content item in the sequence of user interactions in the first user trajectory, a reward for the first content item may be calculated based on a window of user interactions that follow the first user interaction.

In 1006, further rewards for the first content item may be calculated using further user trajectories having user interactions with the first content item. In some cases, a further reward for the first content item may be calculated using the first user trajectory having a further user interaction with the first content item.

In 1008, an engagement score for the first content item may be determined based on the reward and further rewards.

In 1010, further engagement scores for further content items may be determined.

In 1012, one or more content items may be output users of the platform based on the engagement score and the further engagement scores.

### Exemplary Method for Training a Model

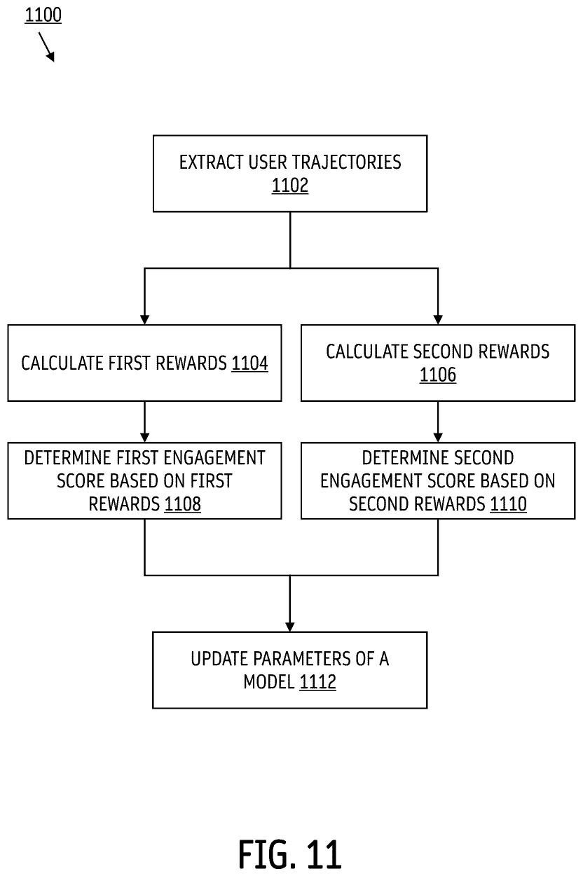

FIG. 11 is a flow chart illustrating a method 1100 for training a model, according to some embodiments of the disclosure. Method 1100 may be carried out by engagement scoring 182 of the FIGS., and update model 814 of FIG. 8.

In 1102, user trajectories may be extracted based on past user session data on a platform. A first user trajectory in the user trajectories can include a first sequence of user interactions on the platform associated with a first user over a period of time. A second user trajectory in the user trajectories can include a second sequence of user interactions on the platform associated with a second user over the period of time.

In 1104, first rewards for a first content item may be calculated using the user trajectories. Each first reward may be based on a window of user interactions that follow a user interaction with the first content item.

In 1106, second rewards for a second content item may be calculated using the user trajectories. Each second reward can be based on a window of user interactions that follow a user interaction with the second content item.

In 1108, a first engagement score for the first content item may be determined based on the first rewards.

In 1110, a second engagement score for the second content item based on the second rewards.

In 1112, parameters of a model to infer an engagement score based on metadata of a content item may be updated using first metadata of the first content item, second metadata of the second content item, first engagement score, and second engagement score. In some cases, parameters of the model may be updated based on data that represents the first content item, data that represents the second content item, first engagement score, and second engagement score.

### Exemplary Computing Device

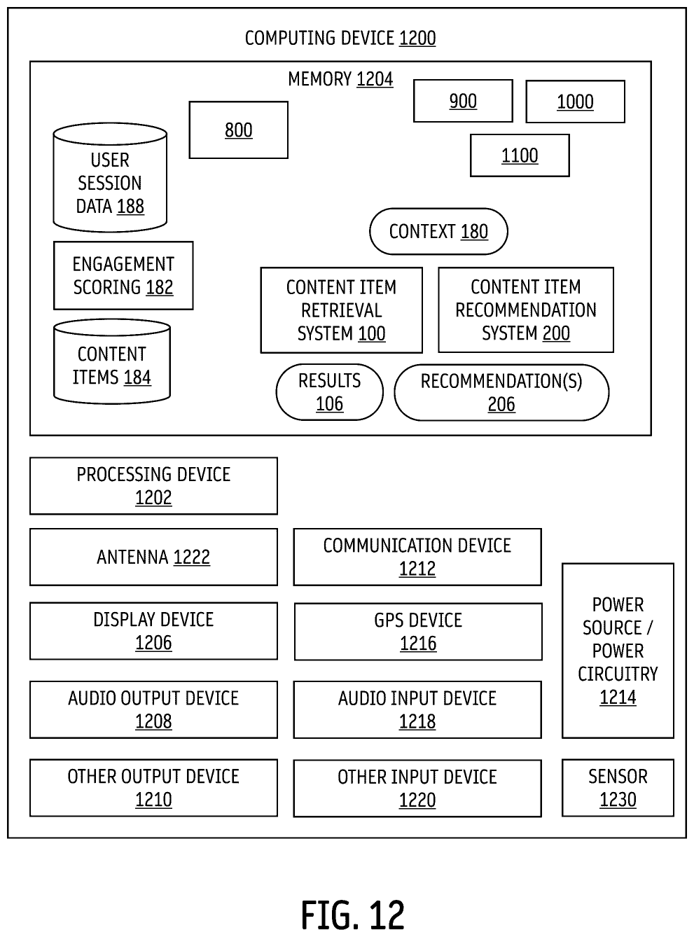

FIG. 12 is a block diagram of an exemplary computing device 1200, according to some embodiments of the disclosure. One or more computing devices 1200 may be used to implement the functionalities described with the FIGS. and herein. A number of components are illustrated in the FIGS. as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 8, and the computing device 1200 may include interface circuitry for coupling to the one or more components. For example, the computing device 1200 may not include a display device 1206, and may include display device interface circuitry (e.g., a connector and driver circuitry) to which a display device 1206 may be coupled. In another set of examples, the computing device 1200 may not include an audio input device 1218 or an audio output device 1208 and may include audio input or output device interface circuitry (e.g., connectors and supporting circuitry) to which an audio input device 1218 or audio output device 1208 may be coupled.

The computing device 1200 may include a processing device 1202 (e.g., one or more processing devices, one or more of the same type of processing device, one or more of different types of processing device). The processing device 1202 may include electronic circuitry that process electronic data from data storage elements (e.g., registers, memory, resistors, capacitors, quantum bit cells) to transform that electronic data into other electronic data that may be stored in registers and/or memory. Examples of processing device 1202 may include a central processing unit (CPU), a graphical processing unit (GPU), a quantum processor, a machine learning processor, an artificial-intelligence processor, a neural network processor, an artificial-intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 1200 may include a memory 1204, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 1204 includes one or more non-transitory computer-readable storage media. In some embodiments, memory 1204 may include memory that shares a die with the processing device 1202.

In some embodiments, memory 1204 includes one or more non-transitory computer-readable media storing instructions executable to perform operations described with the FIGS. and herein, such as the methods illustrated in FIGS. 1-3 and 8-11.

Memory 1204 may store instructions that encode one or more exemplary parts. Exemplary parts that may be encoded as instructions and stored in memory 1204 are depicted. Exemplary parts may include one or more components of system 800 of FIG. 8. Exemplary parts may include one or more components of content item retrieval system 100 of FIG. 1. Exemplary parts may include one or more components of engagement scoring 182 of the FIGS. Exemplary parts may include one or more components of content item recommendation system 200 of FIG. 2. The instructions stored in the one or more non-transitory computer-readable media may be executed by processing device 1202.

In some embodiments, memory 1204 may store data, e.g., data structures, binary data, bits, metadata, files, blobs, etc., as described with the FIGS. and herein. Exemplary data that may be stored in memory 1204 are depicted. Exemplary data may include user session data 188. Exemplary data may include content items 184.

In some embodiments, memory 1204 may store one or more machine learning models (and or parts thereof) that are used in at least content item retrieval system 100 of FIG. 1, engagement scoring 182 of the FIGS., content item recommendation system 200 of FIG. 2. Memory 1204 may store model 802 of FIG. 8 and/or trained model 882 of FIG. 8. Memory 1204 may store training data for training the one or more machine learning models. Memory 1204 may store input data, output data, intermediate outputs, intermediate inputs of one or more machine learning models. Memory 1204 may store instructions to perform one or more operations of the machine learning model. Memory 1204 may store one or more parameters used by the machine learning model. Memory 1204 may store information that encodes how processing units of the machine learning model are connected with each other.

In some embodiments, the computing device 1200 may include a communication device 1212 (e.g., one or more communication devices). For example, the communication device 1212 may be configured for managing wired and/or wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1212 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1212 may operate in accordance with other wireless protocols in other embodiments. The computing device 1200 may include an antenna 1222 to facilitate wireless communications and/or to receive other wireless communications (such as radio frequency transmissions). The computing device 1200 may include receiver circuits and/or transmitter circuits. In some embodiments, the communication device 1212 may manage wired communications, such as electrical, optical, or any other suitable communication protocols (e.g., the Ethernet). As noted above, the communication device 1212 may include multiple communication chips. For instance, a first communication device 1212 may be dedicated to shorter-range wireless communications such as Wi-Fi or Bluetooth, and a second communication device 1212 may be dedicated to longer-range wireless communications such as global positioning system (GPS), EDGE, GPRS, CDMA, WiMAX, LTE, EV-DO, or others. In some embodiments, a first communication device 1212 may be dedicated to wireless communications, and a second communication device 1212 may be dedicated to wired communications.

The computing device 1200 may include power source/power circuitry 1214. The power source/power circuitry 1214 may include one or more energy storage devices (e.g., batteries or capacitors) and/or circuitry for coupling components of the computing device 1200 to an energy source separate from the computing device 1200 (e.g., DC power, AC power, etc.).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include a sensor 1230 (or one or more sensors). The computing device 1200 may include corresponding interface circuitry, as discussed above). Sensor 1230 may sense physical phenomenon and translate the physical phenomenon into electrical signals that can be processed by, e.g., processing device 1202. Examples of sensor 1230 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1200 may include another output device 1210 (or corresponding interface circuitry, as discussed above). Examples of the other output device 1210 may include an audio codec, a video codec, a printer, a wired or wireless transmitter for providing information to other devices, haptic output device, gas output device, vibrational output device, lighting output device, home automation controller, or an additional storage device.

The computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1200 may have any desired form factor, such as a handheld or mobile computer system (e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 1200 may be any other electronic device that processes data.

### SELECT EXAMPLES

Example 1 provides a method, including extracting a first user trajectory including a first sequence of user interactions with content items on a platform associated with a first user over a period of time; extracting a second user trajectory including a second sequence of user interactions with content items on the platform associated with a second user over the period of time; computing a first reward for a first user interaction with a first content item in the first sequence based on a window of user interactions with content items that follow the first user interaction in the first sequence; computing a second reward for a second user interaction with the first content item in the second sequence based on the window of user interactions with content items that follow the second user interaction in the second sequence; aggregating rewards computed for the first content item, the rewards having the first reward and the second reward; and determining a first engagement score for the first content item based on the rewards computed for the first content item.

Example 2 provides the method of example 1, where: the first sequence of user interactions includes a sequence of content items watched by the first user on the platform; and the second sequence of user interactions includes a sequence of content items watched by the second user on the platform.

Example 3 provides the method of example 1 or 2, where the period of time is greater than or equal to 30 days.

Example 4 provides the method of any one of examples 1-3, where the first user and the second user belong to a same demographic.

Example 5 provides the method of any one of examples 1-4, where the first sequence of user interactions and the second sequence of user interactions are associated with one or more same contextual factors.

Example 6 provides the method of any one of examples 1-5, where the window of user interactions specifies a predetermined number of user interactions that follow a user interaction in a sequence of user interactions.

Example 7 provides the method of any one of examples 1-6, where computing the first reward includes determining a contribution value for each user interaction with a particular content item in the window; and summing the contribution values determined for the user interactions with content items in the window.

Example 8 provides the method of example 7, where determining the contribution value includes determining the contribution value based on a relationship between the first content item and the particular content item.

Example 9 provides the method of example 7 or 8, where determining the contribution value includes determining whether the first content item and the particular content item are the same; and in response to determining the first content item and the particular content item are the same, setting the contribution value to a maximum contribution value.

Example 10 provides the method of any one of examples 7-9, where determining the contribution value includes determining whether an affinity between the first content item and the particular content item crosses a threshold; and in response to determining the affinity crosses a threshold, setting the contribution value to a maximum contribution value.

Example 11 provides the method of example 10, where the affinity is determined based on distance between a first embedding generated by a model based on first metadata of the first content item and a second embedding generated by the model based on second metadata of the second content item.

Example 12 provides the method of any one of examples 7-11, where determining the contribution value includes determining whether the first content item and the particular content item are not the same and not similar; and in response to determining the first content item and the particular content item are not the same and not similar, setting the contribution value based on a position of the user interaction with the particular content item in the window.

Example 13 provides the method of example 12, where the contribution value based on the position of the user interaction with the particular content item in the window decays as the position increases.

Example 14 provides the method of any one of examples 1-13, where determining the first engagement score for the first content item based on the rewards computed for the first content item includes determining the first engagement score based on a probability distribution formed using the aggregated rewards computed for the first content item.

Example 15 provides the method of any one of examples 1-14, where determining the first engagement score for the first content item based on the rewards computed for the first content item includes determining the first engagement score based on a lower confidence bound of a distribution formed using the aggregated rewards computed for the first content item.

Example 16 provides a method, including extracting user trajectories based on past user session data on a platform, where a first user trajectory in the user trajectories includes a sequence of user interactions on the platform associated with a user over a period of time; for a first user interaction with a first content item in the sequence of user interactions in the first user trajectory, calculating a reward for the first content item based on a window of user interactions that follow the first user interaction; calculating further rewards for the first content item using further user trajectories having user interactions with the first content item; determining an engagement score for the first content item based on the reward and further rewards; determining further engagement scores for further content items; and outputting one or more content items to users of the platform based on the engagement score and the further engagement scores.

Example 17 provides the method of example 16, where the sequence of user interactions includes a sequence of content items watched by the user on the platform.

Example 18 provides the method of example 16 or 17, where the period of time is greater than or equal to 30 days.

Example 19 provides the method of any one of examples 16-18, where the user trajectories are associated with users that belong to a same demographic.

Example 20 provides the method of any one of examples 16-19, where the user trajectories are associated with one or more same contextual factors.

Example 21 provides the method of any one of examples 16-20, where the window of user interactions specifies a predetermined number of user interactions that follow a user interaction in a sequence of user interactions.

Example 22 provides the method of any one of examples 16-21, where calculating the reward includes determining a contribution value for each user interaction with a particular content item in the window; and summing the contribution values determined for the user interactions with content items in the window.

Example 23 provides the method of example 22, where determining the contribution value includes determining the contribution value based on a relationship between the first content item and the particular content item.

Example 24 provides the method of example 22 or 23, where determining the contribution value includes determining whether the first content item and the particular content item are the same; and in response to determining the first content item and the particular content item are the same, setting the contribution value to a maximum contribution value.

Example 25 provides the method of any one of examples 22-24, where determining the contribution value includes determining whether an affinity between the first content item and the particular content item crosses a threshold; and in response to determining the affinity crosses a threshold, setting the contribution value to a maximum contribution value.

Example 26 provides the method of example 25, where the affinity is determined based on distance between a first embedding generated by a model based on first metadata of the first content item and a second embedding generated by the model based on second metadata of the second content item.

Example 27 provides the method of any one of examples 22-26, where determining the contribution value includes determining whether the first content item and the particular content item are not the same and not similar; and in response to determining the first content item and the particular content item are not the same and not similar, setting the contribution value based on a position of the user interaction with the particular content item in the window.

Example 28 provides the method of example 27, where the contribution value based on the position of the user interaction with the particular content item in the window decays as the position increases.

Example 29 provides the method of any one of examples 16-28, where determining the engagement score for the first content item based on the reward and the further rewards computed for the first content item includes determining the engagement score based on a probability distribution formed using the reward and the further rewards computed for the first content item.

Example 30 provides the method of any one of examples 16-29, where determining the engagement score for the first content item based on the reward and the further rewards computed for the first content item includes determining the engagement score based on a lower confidence bound of a distribution formed using the reward and the further rewards computed for the first content item.

Example 31 provides a method, including extracting user trajectories based on past user session data on a platform, where a first user trajectory in the user trajectories includes a first sequence of user interactions on the platform associated with a first user over a period of time, and a second user trajectory in the user trajectories includes a second sequence of user interactions on the platform associated with a second user over the period of time; calculating first rewards for a first content item using the user trajectories, each first reward being based on a window of user interactions that follow a user interaction with the first content item; calculating second rewards for a second content item using the user trajectories, each second reward being based on a window of user interactions that follow a user interaction with the second content item; determining a first engagement score for the first content item based on the first rewards; determining a second engagement score for the second content item based on the second rewards; and updating parameters of a model to infer an engagement score based on metadata of a content item using first metadata of the first content item, second metadata of the second content item, first engagement score, and second engagement score.

Example 32 provides the method of example 31, where: the first sequence of user interactions includes a sequence of content items watched by the first user on the platform; and the second sequence of user interactions includes a sequence of content items watched by the second user on the platform.

Example 33 provides the method of example 31 or 32, where the period of time is greater than or equal to 30 days.

Example 34 provides the method of any one of examples 31-33, where the first user and the second user belong to a same demographic.

Example 35 provides the method of any one of examples 31-34, where the first sequence of user interactions and the second sequence of user interactions are associated with one or more same contextual factors.

Example 36 provides the method of any one of examples 31-35, where the window of user interactions specifies a predetermined number of user interactions that follow a user interaction in a sequence of user interactions.

Example 37 provides the method of any one of examples 31-36, where calculating the first rewards and calculating the second rewards include determining a contribution value for each user interaction with a particular content item in the window; and summing the contribution values determined for the user interactions with content items in the window.

Example 38 provides the method of example 37, where determining the contribution value includes determining the contribution value based on a relationship between the first content item and the particular content item.

Example 39 provides the method of example 37 or 38, where determining the contribution value includes determining whether the first content item and the particular content item are the same; and in response to determining the first content item and the particular content item are the same, setting the contribution value to a maximum contribution value.

Example 40 provides the method of any one of examples 37-39, where determining the contribution value includes determining whether an affinity between the first content item and the particular content item crosses a threshold; and in response to determining the affinity crosses a threshold, setting the contribution value to a maximum contribution value.

Example 41 provides the method of example 40, where the affinity is determined based on distance between a first embedding generated by a model based on first metadata of the first content item and a second embedding generated by the model based on second metadata of the second content item.

Example 42 provides the method of any one of examples 37-41, where determining the contribution value includes determining whether the first content item and the particular content item are not the same and not similar; and in response to determining the first content item and the particular content item are not the same and not similar, setting the contribution value based on a position of the user interaction with the particular content item in the window.

Example 43 provides the method of example 42, where the contribution value based on the position of the user interaction with the particular content item in the window decays as the position increases.

Example 44 provides the method of any one of examples 31-43, where: determining the first engagement score for the first content item based on the first rewards includes determining the first engagement score based on a first probability distribution formed using the first rewards; and determining the second engagement score for the second content item based on the second rewards includes determining the second engagement score based on a second probability distribution formed using the second rewards.

Example 45 provides the method of any one of examples 31-44, where: determining the first engagement score for the first content item based on the first includes determining the first engagement score based on a lower confidence bound of a first distribution formed using the first rewards; and determining the second engagement score for the second content item based on the second includes determining the second engagement score based on a lower confidence bound of a second distribution formed using the second rewards.

Example A provides one or more non-transitory computer-readable media storing instructions that, when executed by one or more processors, cause the one or more processors to perform any one of the methods provided in examples 1-45 and methods described herein.

Example B provides an apparatus comprising means to carry out or means for carrying out any one of the computer-implemented methods provided in examples 1-45 and methods described herein.

Example C provides a computer-implemented system, comprising one or more processors, and one or more non-transitory computer-readable media storing instructions that, when executed by the one or more processors, cause the one or more processors to perform any one of the methods provided in examples 1-45 and methods described herein.

Example D provides a computer-implemented system comprising one or more components illustrated in FIG. 1 to perform operations described herein.

Example E provides a computer-implemented system comprising one or more components illustrated in FIG. 2 to perform operations described herein.

Example F provides a computer-implemented system comprising one or more components illustrated in FIG. 3 to perform operations described herein.

Example E provides a computer-implemented system comprising one or more components illustrated in FIG. 8 to perform operations described herein.

### VARIATIONS AND OTHER NOTES

Although the operations of the example methods shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method, comprising:
extracting a first user trajectory comprising a first sequence of user interactions with content items on a platform associated with a first user over a period of time;
extracting a second user trajectory comprising a second sequence of user interactions with content items on the platform associated with a second user over the period of time;
computing a first reward for a first user interaction with a first content item in the first sequence based on a window of user interactions with content items that follow the first user interaction in the first sequence;
computing a second reward for a second user interaction with the first content item in the second sequence based on the window of user interactions with content items that follow the second user interaction in the second sequence;
aggregating rewards computed for the first content item, the rewards having the first reward and the second reward; and
determining a first engagement score for the first content item based on the rewards computed for the first content item.

2. The method of claim 1, wherein:
the first sequence of user interactions comprises a sequence of content items watched by the first user on the platform; and
the second sequence of user interactions comprises a sequence of content items watched by the second user on the platform.

3. The method of claim 1, wherein the period of time is greater than or equal to 30 days.

4. The method of claim 1, wherein the first user and the second user belong to a same demographic.

5. The method of claim 1, wherein the first sequence of user interactions and the second sequence of user interactions are associated with one or more same contextual factors.

6. The method of claim 1, wherein the window of user interactions specifies a predetermined number of user interactions that follow a user interaction in a sequence of user interactions.

7. The method of claim 1, wherein computing the first reward comprises:
determining a contribution value for each user interaction with a particular content item in the window; and
summing the contribution values determined for the user interactions with content items in the window.

8. The method of claim 7, wherein determining the contribution value comprises determining the contribution value based on a relationship between the first content item and the particular content item.

9. The method of claim 7, wherein determining the contribution value comprises:
determining whether the first content item and the particular content item are the same; and
in response to determining the first content item and the particular content item are the same, setting the contribution value to a maximum contribution value.

10. The method of claim 7, wherein determining the contribution value comprises:
determining whether an affinity between the first content item and the particular content item crosses a threshold; and
in response to determining the affinity crosses a threshold, setting the contribution value to a maximum contribution value.

11. The method of claim 10, wherein the affinity is determined based on distance between a first embedding generated by a model based on first metadata of the first content item and a second embedding generated by the model based on second metadata of the second content item.

12. The method of claim 7, wherein determining the contribution value comprises:
determining whether the first content item and the particular content item are not the same and not similar; and
in response to determining the first content item and the particular content item are not the same and not similar, setting the contribution value based on a position of the user interaction with the particular content item in the window.

13. The method of claim 12, wherein the contribution value based on the position of the user interaction with the particular content item in the window decays as the position increases.

14. The method of claim 1, wherein determining the first engagement score for the first content item based on the rewards computed for the first content item comprises:
determining the first engagement score based on a probability distribution formed using the aggregated rewards computed for the first content item.

15. The method of claim 1, wherein determining the first engagement score for the first content item based on the rewards computed for the first content item comprises:
determining the first engagement score based on a lower confidence bound of a distribution formed using the aggregated rewards computed for the first content item.

16. One or more non-transitory computer-readable media storing instructions that, when executed by one or more processors, cause the one or more processors to:
extract a first user trajectory comprising a first sequence of user interactions with content items on a platform associated with a first user over a period of time;
extract a second user trajectory comprising a second sequence of user interactions with content items on the platform associated with a second user over the period of time;
compute a first reward for a first user interaction with a first content item in the first sequence based on a window of user interactions with content items that follow the first user interaction in the first sequence;
compute a second reward for a second user interaction with the first content item in the second sequence based on the window of user interactions with content items that follow the second user interaction in the second sequence;
aggregate rewards computed for the first content item, the rewards having the first reward and the second reward; and
determine a first engagement score for the first content item based on the rewards computed for the first content item.

17. The one or more non-transitory computer-readable media of claim 16, wherein:
the first sequence of user interactions comprises a sequence of content items watched by the first user on the platform; and
the second sequence of user interactions comprises a sequence of content items watched by the second user on the platform.

18. The one or more non-transitory computer-readable media of claim 16, wherein computing the first reward comprises:
determining a contribution value for each user interaction with a particular content item in the window; and
summing the contribution values determined for the user interactions with content items in the window.

19. A computer-implemented system, comprising:
one or more processors, and
one or more non-transitory computer-readable media storing instructions that, when executed by the one or more processors, cause the one or more processors to:
extract a first user trajectory comprising a first sequence of user interactions with content items on a platform associated with a first user over a period of time;
extract a second user trajectory comprising a second sequence of user interactions with content items on the platform associated with a second user over the period of time;
compute a first reward for a first user interaction with a first content item in the first sequence based on a window of user interactions with content items that follow the first user interaction in the first sequence;
compute a second reward for a second user interaction with the first content item in the second sequence based on the window of user interactions with content items that follow the second user interaction in the second sequence;
aggregate rewards computed for the first content item, the rewards having the first reward and the second reward; and
determine a first engagement score for the first content item based on the rewards computed for the first content item.

20. The computer-implemented system of claim 19, wherein determining the first engagement score for the first content item based on the rewards computed for the first content item comprises:
determining the first engagement score based on a lower confidence bound of a distribution formed using the aggregated rewards computed for the first content item.
